(19) United States
(12) Patent Application Publication
(10) Pub. No.: US 2016/0349406 A1
(43) Pub. Date: Dec. 1, 2016

(54) LOCATOR DEVICE FOR NONMETALLIC UNDERGROUND OBJECTS

(71) Applicant: Mohamed Hennawy, Longwood, FL (US)

(72) Inventor: Mohamed Hennawy, Longwood, FL (US)

(21) Appl. No.: 14/725,791

(22) Filed: May 29, 2015

(51) Int. Cl. G01V 15/00; G01V 3/08

(52) U.S. Cl. CPC G01V 15/00; G01V 3/08

(57) ABSTRACT

A locator device for underground objects includes a metallic strip that is embedded within a protective waterproof coating. One or more tethers are positioned linearly or transverse to the cover, and secure the device to a nonmetallic underground pipe. A plurality of sleeves and connectors are disposed along the cover. The sleeves facilitate the transverse orientation of the device, and the connectors engage multiple devices together in a serial manner.

### TECHNICAL FIELD

The present invention relates generally to underground utilities, and more particularly to a device for locating nonmetallic underground objects utilizing a metal detector.

### BACKGROUND

The statements in this section merely provide background information related to the present disclosure and may not constitute prior art.

Most underground utilities such as various pipes and conduits, for example, are located less than 10 ft below ground. However, the exact layout and location of these lines are often unknown, as engineering drawings are sometimes incomplete, out of date, or inaccurate. In some instances, no formal plans exist, such as those for irrigation systems and the like. Because of the existence and increased use of nonmetallic pipe and conduit, and the fact that horizontal drilling is replacing traditional trenching methods, the need for pipe and conduit detectors is even more important today than it has been in the past.

There are many known systems and methods for accurately detecting underground items that are constructed from metal. The most common of these is the metal detector which is a relatively inexpensive and simple to operate. Unfortunately, however, metal detectors are unable to detect nonmetallic items. This is especially problematic, as most of the utility pipes in use today are constructed from nonmetallic materials. For this reason, there has been recent emphasis in the testing and development of acoustic devices which utilize sound waves to penetrate the ground (also referred to as ground penetrating radar), in order to identify underground obstacles. Although useful in various circumstances, these devices are extremely expensive to acquire, and often require special training to operate. As such, it is not financially feasible for smaller operations to obtain and utilize such devices.

Accordingly, it would be beneficial to provide a simple locator device which can be secured onto nonmetallic underground facilities, in order to allow the same to be quickly and easily located utilizing a commercially available metal detector.

### SUMMARY OF THE INVENTION

The present invention is directed to a locator device for underground objects. One embodiment of the present invention can include a metallic strip that is embedded within a protective coating. The protective coating can be waterproof and can include one or more tethers extending outward therefrom. The tethers can function to secure the device onto an underground object such as a pipe.

Another embodiment of the present invention can include a series of sleeves for receiving one or more tethers, and for positioning the same transversely with the protective cover, so as to allow the device to be secured longitudinally along an underground pipe. Some embodiments can further include connectors for serially engaging multiple devices along an underground pipe, and a curved bottom surface that conforms to the diameter of the pipe.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of a locator device for nonmetallic underground objects that is useful for understanding the inventive concepts disclosed herein.

FIG. 2A is another top view of a locator device for nonmetallic underground objects in accordance with one embodiment of the invention.

FIG. 2B is a partial cross sectional view of the locator device for nonmetallic underground objects of FIG. 2A.

FIG. 3 is a perspective view of the locator device for nonmetallic underground objects in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

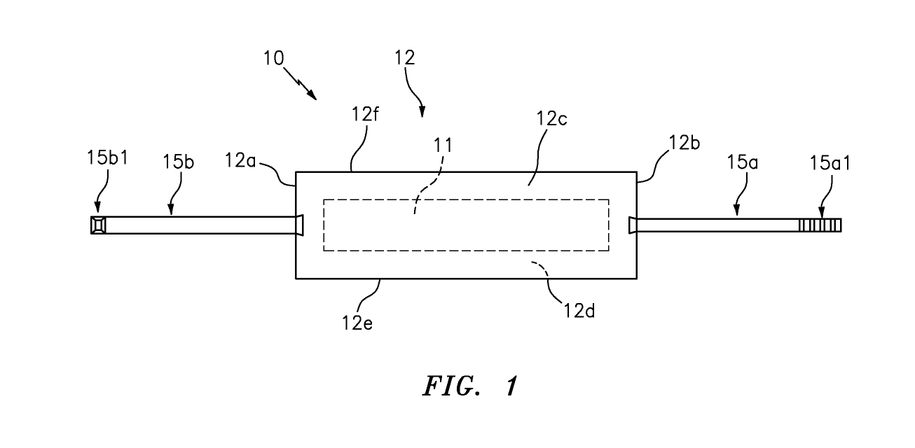

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

Various embodiments of a locator device for nonmetallic underground objects 10 are described below with respect to the drawings. As shown in FIG. 1, one embodiment of the device can include, essentially, an elongated metal strip that is protected by a waterproof cover and is secured to an underground object via a tether.

In the illustrated embodiment, the metal strip 11 can include an elongated, generally rectangular shape that is constructed from steel. Of course, any number of different shapes, sizes and thicknesses are also contemplated, so as to provide the strip with a surface area that is capable of being located by a metal detector. Moreover, virtually any type of metal can be utilized, such as copper, iron, zinc, aluminum, gold and/or silver, for example.

The protective cover 12 can fully encompass the strip 11, so as to protect the same against damage and/or rust, when exposed to the elements. In one embodiment, the cover 12 can also have a generally rectangular shape that includes a first end 12a, a second end 12b, a top surface 12c, a bottom surface 12d and a pair of opposing side surfaces 12e and 12f.

The cover can be constructed from any number of non-metallic, lightweight and waterproof materials such as plastic, vinyl, and/or synthetic rubber, for example, that are suitable for prolonged exposure to an underground environment. Of course, the cover can also be constructed to include any number of different shapes.

Although dimensions are not critical, in one embodiment the metal strip 11 and the cover 12 can include a length (i.e., measured from the first end 12a to the second end 12b) of between approximately 2 and 6 inches, and a width (i.e., measured from the opposing sides 12c and 12d) of between approximately 0.25 and 1.5 inches. Such dimensions presenting a profile that is suitable for being identified by a commercially available metal detector at an underground depth of approximately 10 feet. Of course, any number of other shapes, sizes and dimensions are also contemplated.

In one embodiment, the tether 15 can include a cable tie having a pair of semi-flexible arms 15a and 15b that extend linearly outward from the first and second ends of the cover 12a and 12b. As shown, the tether arms include a plurality of teeth 15a1 and a pawl 15b1, which can engage to form a loop that is tightened onto or around an underground object such as a pipe, for example.

Although described above as including a specific type of tether and location along the protective cover, this is for illustrative purposes only, as any number of devices capable of securing the device 10 onto an nonmetallic object in either a permanent or a nonpermanent manner are also contemplated. Several nonlimiting examples can include opposing strips of hook and loop material (i.e. Velcro®), rope, straps and/or wire, for example. In either instance, the tether(s) can be permanently secured to the protective cover and/or the metal strip in accordance with known manufacturing techniques, such as a permanent adhesive, stitching, and/or welding, for example.

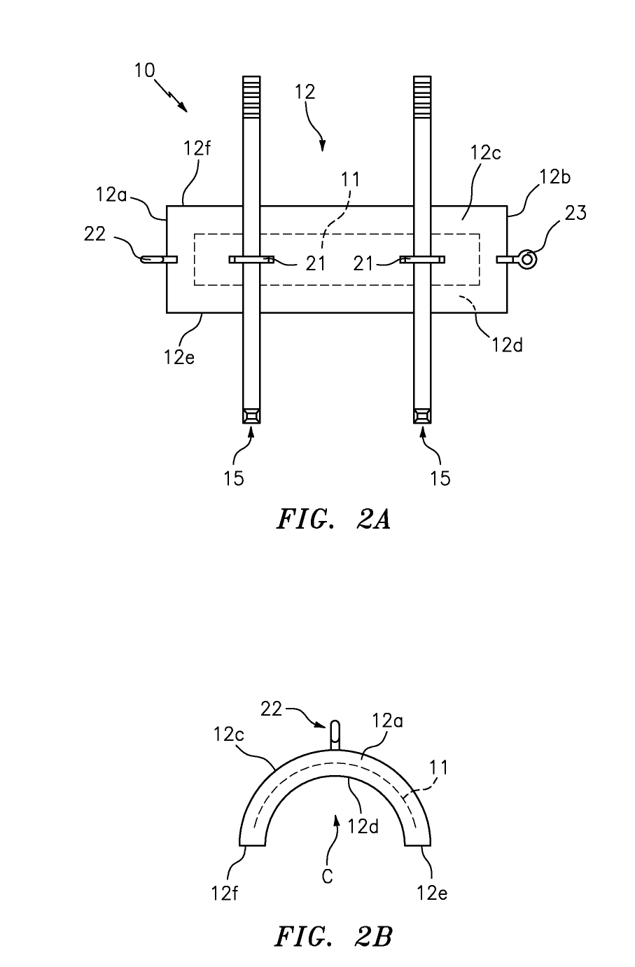

FIG. 2A illustrates another embodiment of the device 10, that further includes a plurality of sleeves that are disposed along the outside of the protective cover, and a pair of in-line connectors. FIG. 2B illustrates a partial cross sectional view of the first end of the device 12a, shown in FIG. 2A. As noted above, the device is intended to be positioned onto underground objects such as pipes. In this regard, various embodiments of the device can be constructed wherein the strip 11 and cover 12 are curved C, along the length thereof, so as to conform to the shape of the pipe. As such, the amount of curvature C can be more or less, depending on the diameter of the pipe itself. In these instances, the tether(s) can also include lengths that are complementary to the diameter of the pipe for which the device is intended to be placed. For example, devices 10 that are manufactured to be secured onto a ½ inch pipe will include a smaller curved section C and shorter length tether than a device that is manufactured to be secured onto a 1 inch pipe.

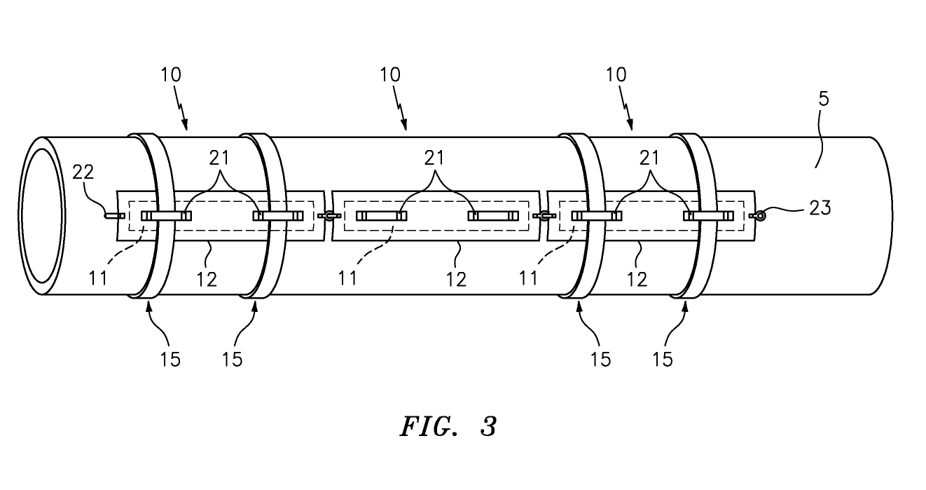

Returning to FIG. 2A, each of the sleeves 21 can preferably be positioned so as to receive one or more of the above described tethers 15, and to position the same in a transverse orientation to the strip 11 and cover 12. Such a feature can allow the device 10 to be secured longitudinally along a nonmetallic object, such as the pipe 5 shown in FIG. 3. In this regard, each of the sleeves can include any shape, size and construction material. In various embodiments, the sleeve can be formed via a series of openings in the cover 12, through which the tether(s) can be positioned.

Moreover, a pair of complementary connectors 22 and 23 can be disposed along the first and second end of the cover 12. In one embodiment, connector 22 can include a hook, and the connector 23 can include a loop. As shown, in FIG. 3, such a feature allows multiple devices 10 to be connected together, so as to be individually and/or collectively secured onto an object such as the illustrated PCV pipe 5, for example.

Although described above as including a particular hook and loop, the connector is not limited to such a configuration. As such, the term “connector,” and “complementary connector” can include any number of different elements capable of securing two items together in either a permanent or nonpermanent manner. Several nonlimiting examples include opposing strips of hook and loop material (i.e. Velcro®), magnetic elements, tethers such as straps and ties, and compression fittings such as hooks, snaps and buttons, for example. Each illustrated connector can be permanently secured to the illustrated portion of the device via a permanent sealer such as glue, adhesive tape, or stitching, for example.

Although not illustrated, other embodiments are also contemplated wherein various identification mechanisms can also be provided. For example, various embodiments can also include one or more strips of magnetic tape which can be encoded with identification information about the object onto which the device is attached. Several nonlimiting examples can include, for example, project drawings, pipe contents, dimensions of the pipe, date of installation, and other such information. Such a feature can provide users the ability to positively identify underground objects without having to physically uncover the same.

As described herein, one or more elements of the locator device for nonmetallic underground objects 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the metal strip 11, the cover 12, the tether 15, the sleeve 21 and/or connectors 22 and 23 for example, may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A locator device, comprising:
an elongated, generally rectangular metallic strip;
a non-metallic waterproof cover that is positioned along an entirety of the metallic strip, said cover including a first end, a second end, a top surface, a bottom surface, a first side surface and a second side surface;
one or more tethers that extend outward from the waterproof cover, each of the one or more tethers functioning to engage a secondary object.

2. The locator device of claim 1, wherein the tether consists of:
a first flexible arm that extends linearly from the first end of the waterproof cover;
a second flexible arm that extends linearly from the second end of the waterproof cover;
a pawl that is disposed along a distal end of the first flexible arm; and
a plurality of teeth that are disposed along a distal end of the second flexible arm.

3. The locator device of claim 1, further comprising:
a plurality of sleeves that are disposed along an outside facing surface of the waterproof cover, each of said sleeves functioning to receive and engage the one or more tethers, and to position the same in a transverse orientation with the waterproof cover.

4. The locator device of claim 1, further comprising:
a pair of complementary connectors that are disposed along the first and second ends of the waterproof cover, said connectors functioning to align and engage a plurality of locator devices in a serial configuration.

5. The locator device of claim 4, wherein the pair of complementary connectors consist of a hook that is disposed along the first end of the waterproof cover, and a loop that is disposed along the second end of the waterproof cover.

6. The locator device of claim 1, wherein the metal strip and the protective cover include a continuous curve along the bottom surface, said curve extending from the first end to the second end of the cover.

7. The locator device of claim 6, wherein said curve corresponds to a dimension of a nonmetallic pipe.

8. The locator device of claim 7, wherein each of the one or more tethers include a length that is complementary to the dimension of the nonmetallic pipe.
